(19) United States
(12) Patent Application Publication
(10) Pub. No.: US 2011/0073717 A1
(43) Pub. Date: Mar. 31, 2011

(54) AIRCRAFT WITH A HYBRID ENERGY SUPPLY

(75) Inventors: Alain Foucault, Le Chatelet En Brie (FR); Etienne Juchauld, Samois Sur Seine (FR); Arnaud Pierrot, Le Mee Sur Seine (FR); Stephane Rousselin, Hericy (FR)

(73) Assignee: SNECMA, Paris (FR)

(21) Appl. No.: 12/994,808

(22) PCT Filed: May 14, 2009
(86) PCT No.: PCT/FR2009/050898

§ 371 Date: Nov. 26, 2010

(30) Foreign Application Priority Data
May 26, 2008 (FR) 0853393

(51) Int. Cl. B64D 27/24; B64D 27/04; B64D 27/02

(52) U.S. Cl. 244/53 R; 244/53 A; 903/902

(57) ABSTRACT

An aircraft with a hybrid power supply, the aircraft comprising:
an external structure (12 to 20);
electrical equipment (34);
internal combustion propulsion means (40); and
means for feeding energy to the propulsion means;
the aircraft being characterized in that it further comprises:
a plurality of converters for directly converting light energy into electrical energy (24), which converters are disposed on at least a fraction of the outside surface of the external structure;
means (32) for comparing the electrical energy produced by said converters with the instantaneous consumption of said electrical equipment (34);
means (36) for recovering the excess electrical energy, if any; and
means (38) for delivering to said propulsion means (40) additional energy taken from said excess electrical energy, if any.

The present invention relates to an aircraft powered with a mixture of energy supplies.

Nearly all aircraft are propelled by means of internal combustion engines. They may be two or four-stroke piston engines for aircraft of low power, or more commonly turbomachines for aircraft of greater power.

Propulsion means of that kind make use of hydrocarbons, essentially gasoline or kerosene. Given the cost of hydrocarbons and the ever-increasing attention given to the problem of pollution, it would be advantageous to be able to reduce the consumption of hydrocarbons and in particular of kerosene.

For this purpose, proposals have been made on an experimental basis for propelling aircraft electrically. Under such circumstances, the energy source is taken either from storage batteries or possibly from a fuel cell, or else from solar panels disposed on the external structures of the aircraft, and the aircraft is propelled by an electric motor.

Nevertheless, given the present cost of solar collectors and their relatively low efficiency, applications are very limited for propelling aircraft by means of an electric motor.

Nevertheless, a large amount of work is presently being done to improve the efficiency of solar collectors and to reduce their costs.

An object of the present invention is to provide an aircraft with a mixture of energy sources that enables the consumption of hydrocarbon to be reduced compared with conventional solutions, when the speed of the aircraft is not too great, e.g. less than 300 kilometers per hour (km/h).

To achieve this object, the invention provides an aircraft with a hybrid power supply, the aircraft comprising:
an external structure;
electrical equipment;
internal combustion propulsion means; and
means for feeding energy to the propulsion means;
the aircraft being characterized in that it further comprises:
a plurality of converters for directly converting light energy into electrical energy, which converters are disposed on at least a fraction of the outside surface of the external structure;
means for comparing the electrical energy produced by said converters with the instantaneous consumption of said electrical equipment;
means for recovering the excess electrical energy, if any; and
means for delivering to said propulsion means additional energy taken from said excess electrical energy, if any.

It can be understood that because of the provisions of the invention, the aircraft has an additional energy source constituted by the electrical energy produced by the converters for directly converting light energy into electrical energy. Such additional energy supply means are preferably used to satisfy the instantaneous consumption of the electrical equipment of the aircraft, with any surplus electrical energy being delivered to the propulsion means that are of the internal combustion type.

This optimizes overall management of the available energy, and in particular of the available electrical energy.

Another advantage of the invention is that it provides an emergency source of electrical energy in the event of failure of other means.

In a first embodiment of the invention, the aircraft is characterized in that the means for delivering the additional energy comprise at least one electric motor powered by said excess electrical energy if any, said electric motor co-operating with said propulsion means.

It can be understood that in this first embodiment, the additional excess energy produced by the converters for converting light energy into electrical energy serves to power an electric motor that co-operates with the propulsion means.

In a second embodiment, the aircraft is characterized in that said means for delivering additional energy comprise:
a hydrogen-production assembly for producing hydrogen from water, said hydrogen-production assembly being fed with said excess electrical energy, if any; and
means for delivering the hydrogen to the heat energy production means.

It can be understood that in this second embodiment, the electrical energy serves to produce hydrogen from the available water and means are also provided for delivering the hydrogen to the internal combustion propulsion-producing means.

In this second embodiment, the aircraft is preferably characterized in that it comprises:
means for condensing at least some of the exhaust gas from the propulsion means;
means for recovering liquid water from the condensate produced; and
means for feeding the hydrogen production assembly with the water obtained in this way.

Other characteristics and advantages of the invention appear better on reading the following description of various embodiments of the invention given as non-limiting examples. The description refers to the accompanying figures, in which:

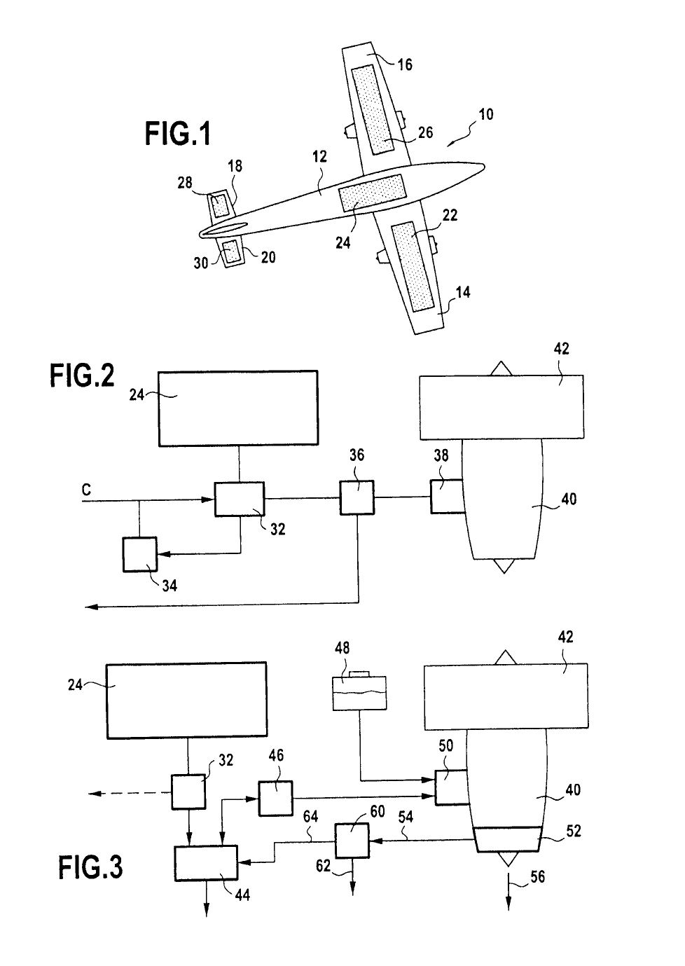

FIG. 1 is a diagrammatic view of an aircraft fitted with light energy to electrical energy converters;

FIG. 2 is a diagram of the energy production device in a first embodiment; and

FIG. 3 is a diagram showing the second embodiment for supplying electrical energy.

In FIG. 1, there can be seen in highly diagrammatic manner the external structure of an aircraft 10 having a fuselage 12, wings 14 and 16, and tail planes 18 and 20. Each of these component elements of the external structure of the aircraft 10 is fitted with converters for converting light energy into electrical energy and given respective references 22, 24, 26, 28, and 30. Naturally, FIG. 1 is given purely by way of example and the zones that are covered with light energy to electrical energy converters should be adapted to the particular outside structure of the aircraft.

With reference initially to FIG. 2, there follows a description of a first embodiment of the invention for supplying additional electrical energy to the propulsion means of the aircraft.

This figure shows a solar panel, e.g. the panel 24 of FIG. 1, which panel is connected to an electricity manager device 32. The electricity manager device receives a control signal C that is representative at all times of the electrical energy requirements of the electrical equipment 34 of the aircraft at all times. The circuits of the manager device 32 include means for comparing the amount of electrical energy being delivered instantaneously by the set of solar panels with the signal C that is representative of the needs of the electrical equipment of the aircraft. If these needs exist, then at least a fraction of the electrical energy produced by the solar panels 24 etc. is transmitted to the electrical equipment of the aircraft. Surplus electrical energy is transmitted to an electronics unit 36 for managing electric motor means that are given overall reference 38 and that are coupled either to the low pressure shaft, or to the high pressure shaft of the propulsion means of the aircraft when the aircraft is propelled by a turbomachine. The electronics unit 36 controls the power supply to the electrical machine 38 that is preferably constituted by the electrical starter motor or by a generator capable of operating as a motor and that is available on all aircraft propulsion means.

It can thus be understood that the invention enables the manager device 32 to cause the electrical energy produced by the solar panels such as 24 to be devoted primarily to the electrical equipment 34 of the aircraft. Part of this electrical energy may be transmitted to the electrical equipment 34 and part of it to the electronics unit 36, depending on the instantaneous requirements for electrical energy of the electrical equipment of the aircraft. If the device 32 detects any excess electrical energy, it is used to power the electric motor 38 via the electronics unit, thus serving either to deliver energy to the internal combustion engines 40 of the aircraft, or to save on the mechanical power taken off from these engines 40 in order to be transformed into electrical power.

It should be emphasized that since the electric motor means already exist, even if they are not always reversible, they enable the invention to be implemented without installing additional equipment.

With reference now to FIG. 3, there follows a description of a second embodiment of the invention. In this second embodiment, any surplus electrical energy produced by the solar sensors is used for hydrolyzing water so as to produce hydrogen, for mixing with the fuel. In FIG. 3, there can be seen a light energy to electrical energy converter 24 that is connected to an electricity manager circuit 32 having exactly the same function as that described with reference to FIG. 2.

The electrical energy in excess over the requirements of the electrical equipment of the aircraft is used in a hydrolyzer 44 that is fed with water. The hydrogen produced by the hydrolyzer 44 is stored in a tank 46. The standard fuel, e.g. kerosene, is stored in a tank 48. The hydrogen stored in the tank 46 and the fuel stored in the tank 48 are fed to a fuel regulator circuit 50 that acts as a function of the availability of hydrogen to define the optimal hydrogen/fuel mixture for use in feeding to the engine 40 of the aircraft.

Preferably, the water used for feeding the hydrolyzer 44 is recovered from the exhaust gas from the engine 40. To do this, a cooling circuit 52 cools the exhaust gas and delivers the cooled fraction of the exhaust gas via a pipe 54 while the non-recycled fraction is discharged by a pipe 56. The cooled exhaust gas feeding the pipe 54 is taken to a circuit 60 for separating water and carbon dioxide. The mixture of carbon dioxide and nitrogen is discharged from the separator 60 by a pipe 62, while the water separated from the remainder of the exhaust gas is taken by a pipe 64 to the hydrolyzer 44.

It can be understood that this second embodiment of the invention presents all of the advantages of the first, since the production of electrical energy by the solar collectors is managed by the circuit 32 to power the electrical equipment of the aircraft as a priority, and it is only the excess portion, if any, that is used for powering the hydrolyzer and thus for producing hydrogen that then constitutes a portion of the fuel for the engine 40. In addition, it should be added that in the preferred embodiment of the invention as described with reference to FIG. 3, the water used in the hydrolyzer is recovered from the exhaust gas of the internal combustion engine 40. Nevertheless, it would not go beyond the ambit of the invention if an independent source of water were used, although that does not constitute the best solution.

1. An aircraft with a hybrid power supply, the aircraft comprising:
an external structure (12 to 20);
electrical equipment (34);
internal combustion propulsion means (40); and
means for feeding energy to the propulsion means;
the aircraft being characterized in that it further comprises:
a plurality of converters (22 to 30) for directly converting light energy into electrical energy, which converters are disposed on at least a fraction of the outside surface of the external structure;
means (32) for comparing the electrical energy produced by said converters with the instantaneous consumption of said electrical equipment (34);
means (36) for recovering the excess electrical energy, if any; and
means (38, 46, 50) for delivering to said propulsion means (40) additional energy taken from said excess electrical energy, if any.

2. An aircraft according to claim 1, characterized in that the means for delivering the additional energy comprise at least one electric motor (38) powered by said excess electrical energy if any, said electric motor co-operating with said propulsion means (40).

3. An aircraft according to claim 2, characterized in that said electric motor (38) is the starter of the propulsion means.

4. An aircraft according to claim 1, characterized in that said means for delivering additional energy comprise:
a hydrogen-production assembly (44) for producing hydrogen from water, said hydrogen-production assembly being fed with said excess electrical energy, if any; and
means (46, 50) for delivering the hydrogen to the heat energy production means.

5. An aircraft according to claim 4, characterized in that it comprises:
means (52) for condensing at least some of the exhaust gas from the propulsion means (40);
means (60) for recovering liquid water from the condensate produced; and
means (64) for feeding the hydrogen production assembly with the water obtained in this way.

6. An aircraft according to claim 5, characterized in that said heat energy production means include a few regulator circuits (50), the hydrogen produced by the hydrogen production means (44, 46) being injected into said combustion chamber.
